(19) United States
(12) Patent Application Publication
(10) Pub. No.: US 2020/0377210 A1
(43) Pub. Date: Dec. 3, 2020

(54) HIGH ENDURANCE MOBILE UNMANNED AERIAL VEHICLE SYSTEM

(71) Applicant: Pegasus Aeronautics Corporation, Waterloo (CA)

(72) Inventors: Matthew McRoberts, Waterloo (CA); Robert P. STRATTON, Pickering (CA)

(21) Appl. No.: 16/886,226

(22) Filed: May 28, 2020

Related U.S. Application Data
(60) Provisional application No. 62/854,549, filed on May 30, 2019.

(51) Int. Cl. B64C 39/02; B64F 3/02

(52) U.S. Cl. CPC B64C 39/022; B64F 3/02; B64C 2201/044; B64C 2201/148; B64C 2201/042; B64C 39/024

(57) ABSTRACT

A high endurance mobile unmanned aerial vehicle system includes a base station and an unmanned aerial vehicle interconnected by a tether which is releasable from the unmanned vehicle. The unmanned vehicle receives electrical power from the base station to operate the vehicle while connected. The unmanned vehicle further includes a hybrid drive system operable to produce electrical power from a fuel carried by the unmanned vehicle such that the unmanned vehicle can start the hybrid drive system, release the tether and fly in a fully mobile mode, away from the base station and tether when desired.

### FIELD OF THE INVENTION

The present invention relates to unmanned aerial vehicle systems. More specifically, the present invention relates to an unmanned aerial vehicle system capable of long endurance flight times and full mobility.

### BACKGROUND OF THE INVENTION

Recent developments in technology have brought unmanned aerial vehicles, commonly referred to as “UAVs” or “drones”, much closer to a practical solution for many real world problems. In particular, the development of UAVs with electric propulsion systems and computer-based flight controllers has revolutionized the UAV space. Proposed uses of these new UAVs include delivery services, surveillance and security duties, survey and aerial sensor platforms, etc.

However, one of the current problems facing the adoption and deployment of UAVs for such uses is the very limited flight time of battery-powered UAVs. Specifically, battery-powered UAVs are limited by the compromise between the weight of the batteries they carry to power their motors, and the amount of payload they can carry, and their total flight time. More recently, UAVs which are powered by hydrogen fuel cells have been developed but the flight times of such systems are also limited by the weight of the fuel they can carry. It is not uncommon for current UAVs with a useful payload to have flight times of less than twenty minutes, and in many cases, even ten minutes or less.

One of the present solutions to address the issue of limited flight time is to use a tethered UAV. A tethered UAV is connected by a specially constructed, lightweight, cable that provides power to the UAV (negating the need for batteries to be on the UAV) while it is hovering above a base station at fixed position, and typically the tether also provides a data connection between the sensors or other payload on the UAV and the base station.

Tethered UAVs are a reasonable solution for fixed surveillance applications, or the like, where the UAV can hover over a more or less fixed position to acquire sensor data, which is then provided to the base station or other location. A tethered UAV can remain aloft for very long periods of time, and it is possible to hover such a UAV and its payload at a height much greater than could easily be achieved with other means for positioning a sensor, such as CCTV camera poles, etc.

However, in many applications the inability of the tethered UAV to move from its tethered position significantly reduces the desirability and usefulness of the UAV. For example, a tethered UAV can be used to provide security at a commercial site, and can provide much better CCTV coverage and/or other sensor information than could be obtained from pole-mounted sensors and cameras. However, if the UAV identifies a possible security incident, such as an intruder, it would be ideal to fly the UAV to where the possible intruder is located to acquire more information to confirm or deny the presence of the intruder and, in the first case, to gather more information to provide to the police or a security team. But, when attached to the tether, the UAV cannot be moved to other locations and thus its potential utility is severely reduced.

More recently, it has been proposed that a tethered UAV can be provided with the ability to disconnect from its tether and operate on carried batteries to achieve full mobility. While this design addresses some of the disadvantages discussed above, in such a case the UAV must carry sufficient batteries to power the UAV when disconnected from the tether. Thus, a compromise must again be made between the weight of the batteries, the UAV's payload and the UAV's flight time when detached from the tether. The result of this compromise is such that, to date, UAVs which can be untethered for mobile flight typically have very limited free flight times (on the order of less than ten minutes) and thus are not very useful for many applications.

Further, once a UAV has disconnected from its tether, it must be landed and reconnected to its tether before it can resume tethered operations, meaning ground personnel must be available to perform this function and care must be taken when landing the UAV to not hit people or objects.

### SUMMARY OF THE INVENTION

It is an object of the present invention to provide a novel system and method of providing a high endurance mobile unmanned aerial vehicle system which obviates, or mitigates, at least one disadvantage of the prior art.

According to a first aspect of the present invention, there is provided an unmanned aerial vehicle system comprising: an unmanned aerial vehicle equipped with fuel storage and a hybrid drive system operable to produce electrical power to operate the unmanned aerial vehicle using fuel from the fuel storage; a base station equipped with a tether extending from the base station and having a distal end releasably electrically connected to the unmanned aerial vehicle, the tether operable to provide electrical power from the base station to operate the unmanned aerial vehicle when attached thereto, and wherein the hybrid drive system is operable to provide electrical power to operate the unmanned vehicle aerial vehicle when the tether is released from the unmanned aerial vehicle.

According to another aspect of the present invention, there is provided an unmanned aerial vehicle system comprising: an unmanned aerial vehicle equipped with at least one battery to provide electrical power to operate the vehicle; a base station equipped with a docking pole and a tether having a first end at the base station and a second end extendable from the distal end of the docking pole, the second end having a releasable electrical connection to connect to the unmanned aerial vehicle, the tether operable to provide electrical power from the base station to operate the unmanned vehicle aerial vehicle and to charge the at least one battery when the electrical connection is connected to the unmanned aerial vehicle and a docking system, comprising a first member located on the docking pole and a second member located on the unmanned aerial vehicle, the docking system cooperating to receive the unmanned aerial vehicle at the end of the docking pole distal the base station and to reconnect the releasable electrical connection at the second end of the tether to the unmanned aerial vehicle.

According to another aspect of the present invention, there is provided an unmanned aerial vehicle comprising: fuel storage; a hybrid drive system operable to produce electrical power to operate the unmanned aerial vehicle using fuel from the fuel storage; an electrical receptacle operable to releasably engage an electrical connector on a tether, which can provide electrical power to operate the unmanned aerial vehicle when attached thereto and wherein the hybrid drive system produces electricity to power the unmanned aerial vehicle when the tether is released from the electrical receptacle.

According to another aspect of the present invention, there is provided a method of operating an unmanned aerial vehicle system, comprising the steps of: releasably connecting a tether to an unmanned aerial vehicle, the tether providing electrical power to operate the unmanned aerial vehicle wile attached to the tether; starting a hybrid drive system on the unmanned aerial vehicle, the hybrid drive system generating electrical power from fuel stored in fuel storage on the unmanned aerial vehicle, the generated electrical power operating the unmanned aerial vehicle; and releasing the tether from the unmanned aerial vehicle when the unmanned aerial vehicle is powered by the hybrid drive system to allow the unmanned aerial vehicle to operate in a fully mobile manner.

### BRIEF DESCRIPTION OF THE DRAWINGS

Preferred embodiments of the present invention will now be described, by way of example only, with reference to the attached Figures, wherein:

FIG. 1 shows a schematic representation of a prior art tethered UAV system;

FIG. 2 shows a schematic representation of a high endurance UAV system in accordance with the present invention;

FIG. 3 shows a schematic representation of another high endurance UAV system in accordance with the present invention with the UAV docked on a docking pole of the system;

FIG. 4 shows the UAV of FIG. 3 hovering over the docking pole with a tether attached;

FIG. 5 shows the UAV of FIG. 3 flying adjacent the docking pole after the tether has been detached; and

FIG. 6 shows a portion of another UAV system in accordance with the present invention showing refueling connections for the UAV when docked.

### DETAILED DESCRIPTION OF THE INVENTION

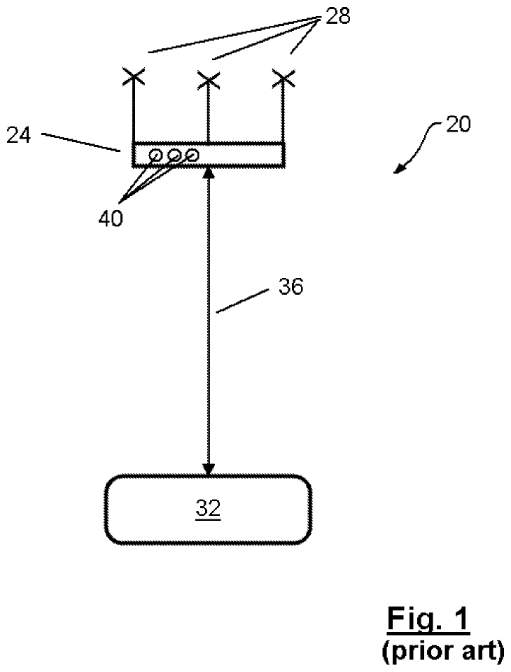

A prior art tethered unmanned aerial vehicle (“UAV”) system is indicated generally at 20 in FIG. 1. System 20 includes a UAV 24, which can be any UAV such as a quad or octo-copter UAV which is capable of hovering. UAV 24 typically includes multiple driven propellers 28, four propellers in the case of a quad-copter, eight propellers in the case of an octo-copter, etc. and UAV 24 is connected to base station 32 via a tether 36.

Tether 36 is typically a lightweight cable providing electrical power from base station 32 to UAV 24 and may also include a data connection between UAV 24 and base station 32. Typically, base station 32 includes a windlass allowing tether 36 to be extended and retracted in a controlled manner as needed.

In some cases, UAV 24 also includes a set of batteries 40 allowing UAV 24 to operate in the absence of power from tether 36 and base station 32, but batteries 40 typically only have sufficient capacity to allow UAV 24 to safely land if base station 32 should experience a fault or otherwise be unable to provide the necessary power to maintain UAV 24 in flight.

More recently, it has been proposed to allow UAV 24 to disengage (i.e. —“drop”) tether 36 to allow UAV 24 to move away from base station 32 when desired. In such cases, batteries 40 must have a greater capacity than would be required to merely power UAV 24 to a safe landing and such greater capacity batteries 40 necessarily have a much greater weight, thus reducing the overall useful payload of UAV 24. Further, currently with even the best batteries and the best design, typical hover-capable UAVs have flight times limited to twenty minutes or less which severely reduces their utility for many applications.

Also, if tether 36 is dropped and UAV 24 flown using power from batteries 40, UAV 24 must subsequently be flown and landed, or be otherwise transported, to base station 32 after its flight is completed to allow tether 36 to be reattached. Depending upon the use case for UAV 24 and its operating location, landing UAV 24 to permit reattachment of tether 36 can entail risks as UAV 24 can contact personnel at base station 32 or adjacent objects, injuring the personnel and/or damaging UAV 24.

Further, depending upon the power delivery capacity of tether 36, batteries 40 may have to be recharged via another connection at base station 32, or elsewhere, before UAV 24 can resume tethered flight from base station 32.

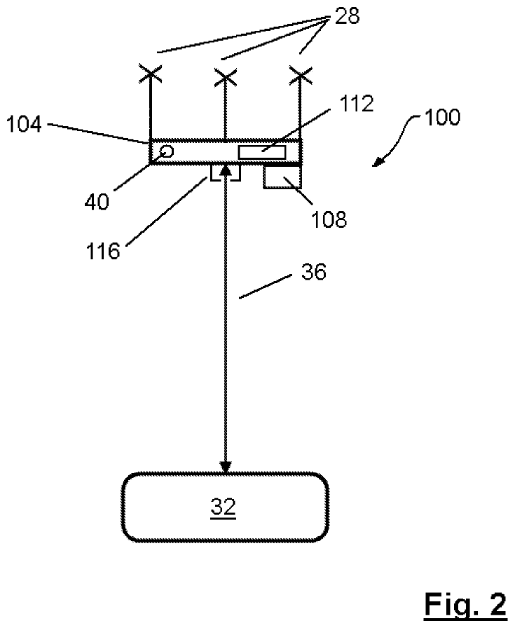

FIG. 2 shows a first example of a UAV system 100 in accordance with some aspects of the present invention, wherein similar components to those described with respect to FIG. 1 are indicated with similar reference numerals. In UAV system 100, a UAV 104 is equipped with a hybrid drive system 108, such as the GE35 or GE70 systems sold by Pegasus Aeronautics Corporation, 60 Bathurst Drive, Unit 25, Waterloo, ON, Canada or a hydrogen fuel cell, such as that produced by Ballard Power for UAVs. Hybrid drive systems convert a fuel to electrical energy. The above-mentioned Pegasus systems employ a fuel, such as a petroleum-based fuel, to operate an internal combustion engine which, in turn, operates a generator to produce the electricity required to operate UAV 104. Alternatively, the hybrid drive can comprise a fuel cell which uses a fuel of pressurized hydrogen gas to produce electricity.

As is well known, due to the much higher gravimetric energy density of combustible fuels and/or hydrogen gas compared to even the best batteries, such hybrid drive systems can provide significantly more electrical energy than a comparable set of batteries of the same weight to allow for longer flight times of a UAV.

While not essential, as will be apparent from the following description, it is preferred in many cases that, as before, UAV 104 include a battery 40, but in this case, battery 40 need only have sufficient capacity to start, or restart, the internal combustion engine of hybrid drive system 108 (if it is an internal combustion engine) and/or to safely land UAV 104 in the event of a loss of power from tether 36 and/or hybrid drive system 108.

UAV 104 further includes a fuel storage tank 112, which stores the fuel (gasoline, JP4, compressed natural gas, hydrogen, etc.) for operating hybrid drive system 108, and a tether release mechanism 116 which allows UAV 104 to disconnect itself from tether 36 when desired.

Tether release mechanism 116 can be remotely operated, receiving a release signal either from base station 32 via tether 36 or from a remote operator via an appropriate radio control command. Tether release systems are known and any suitable system as would occur to those of skill in the art can be employed with the present invention.

In use, UAV system 100 can be operated as follows. UAV 104 can be deployed in a tethered state, with tether 36 releasably connected to UAV 104 and UAV 104 drawing its power requirements from base station 32, via tether 36. UAV 104 can be positioned at a desired altitude adjacent base station 32, controlled to hover at that position, and any payload cameras and/or other sensors on UAV 104 can be operated in the appropriate manner.

If it is desired to operate UAV 104 in a fully mobile configuration, for example to move UAV 104 to a new position to investigate a possible intruder at a secured site, UAV 104 will be instructed to switch to a mobile operating mode, wherein power for UAV 104 is supplied from hybrid drive system 108 and UAV 104 is disconnected from tether 36 to permit mobile flight operations. UAV 104 can be instructed to switch to mobile operating mode via a radio control signal sent by the operator, or by a signal received from base station 32 via tether 36 or in any other suitable manner as would be apparent to those of skill in the art.

Upon receipt of the appropriate signal to switch to mobile operations mode, hybrid drive system 108 will start producing electrical power to operate UAV 104 and tether 36 can be released from UAV 104 by activating tether release mechanism 116.

If desired, system 200 can be equipped with a safety interlock which operates such that only when hybrid drive system 108 is operating correctly (which can either be verified by the remote operator reviewing appropriate telemetry received from UAV 104 or which can be self-verified by the control systems on UAV 104), can tether release mechanism 116 be activated and tether 36 dropped by UAV 104.

At this point, UAV 104 is fully mobile and can be flown to a desired location by the operator of the UAV, or via an autonomous control system. The mobile operation of UAV 104 is limited only by the amount of fuel in fuel storage tank 112 and the fuel consumption rate of hybrid drive system 108.

Ideally, UAV 104 can be flown on a “complete mission” where UAV 104 is flown from base station 32 to the desired location, any and all necessary observations are made and then UAV 104 can be returned to the location of base station 32 where it will be landed, refueled and reattached to tether 36 for redeployment.

However, if fuel storage tank 112 has insufficient fuel for a “complete mission” UAV 104 can be landed at another location and manually moved back to base station 32 and/or battery 40 (if present) can assist in landing or flying (depending upon the capacity of battery 40) UAV 104 once the fuel in fuel storage tank 112 is exhausted.

It is contemplated that, with a suitable hybrid drive system 108 and appropriate amount of fuel in fuel storage tank 112, UAV 104 can operate in mobile/untethered mode for as much as two hours, or more, resulting in a greatly enhanced utility for UAV system 100.

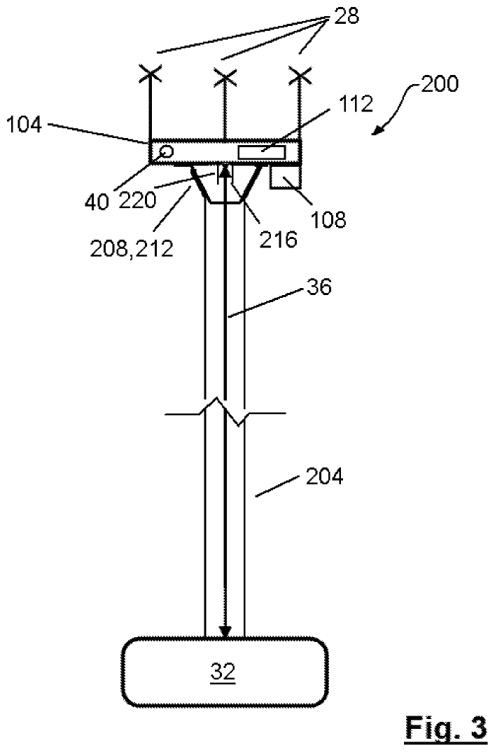

FIGS. 3, 4 and 5 show a second example of a UAV system 200 in accordance with some aspects of the present invention, wherein similar components to those described with respect to FIGS. 1 and 2 are indicated with similar reference numerals.

In UAV system 200, base station 32 is further equipped with a UAV docking pole 204. Tether 36 runs from base station 32 to the distal end of docking pole 204 and can be drawn out of the distal end of docking pole 204 during tethered flight of UAV 104. Preferably, docking pole 204 is telescopic and can be extended vertically as needed to receive UAV 104 (as described below) and retracted when not in use. However, it is also contemplated that docking pole 204 can be a fixed height.

The upper extremity of docking pole 204 is equipped with a docking system which allows UAV 104 to dock with pole 204. In the illustrated embodiment, the docking system comprises a female docking collar 208 which is complementary in shape to a male docking member 212 on UAV 104.

As will be apparent to those of skill in the art, the present invention is not limited to a docking system comprising the above-described collar 208 and member 212 and any other suitable docking system, as will readily occur to those of skill in the art, can be employed as desired.

A suitable electrical connector 216 is electrically connected to the end of tether 36 distal base station 32 and is received within a complementary, releasable, electrical receptacle 220 on UAV 104. When UAV 104 is docked upon pole 204, connector 216 engages receptacle 220 and UAV 104 can then receive electrical power from tether 36 to power UAV 104 for tethered flight and/or to recharge batteries 40.

In addition to electrical power, tether 36 can also provide a data connection between UAV 104 and base station 32 if desired and, in such a case, the data signals can be carried over the electrical power conductors in tether 36 or can carried by additional data signal lines in tether 36. In this latter case, receptacle 220 and connector 216 will include the necessary additional connections for the data signal lines.

Docking collar 208 and docking member 212 cooperate to allow UAV 104 to be docked atop docking pole 204 with docking collar 208 and docking member 212 cooperating to align and engage connector 216 with receptacle 220 as UAV 104 is lowered onto docking pole 204, as shown in FIG. 3.

Once connector 216 is engaged with receptacle 220, UAV 104 can again be powered from base station 32, recharging batteries 40 if necessary, and hybrid drive system 108 can be shut down. UAV 104 can remain in this docked position until it is desired to enter a flight mode, or UAV 104 can undock (as described below) and enter a tethered flight mode or a fully mobile flight mode.

In the case, also contemplated herein, where UAV 104 does not have hybrid drive system 108, and is instead only powered by batteries 40, UAV 104 can remain docked while batteries 40 are recharged with power supplied from base station 32.

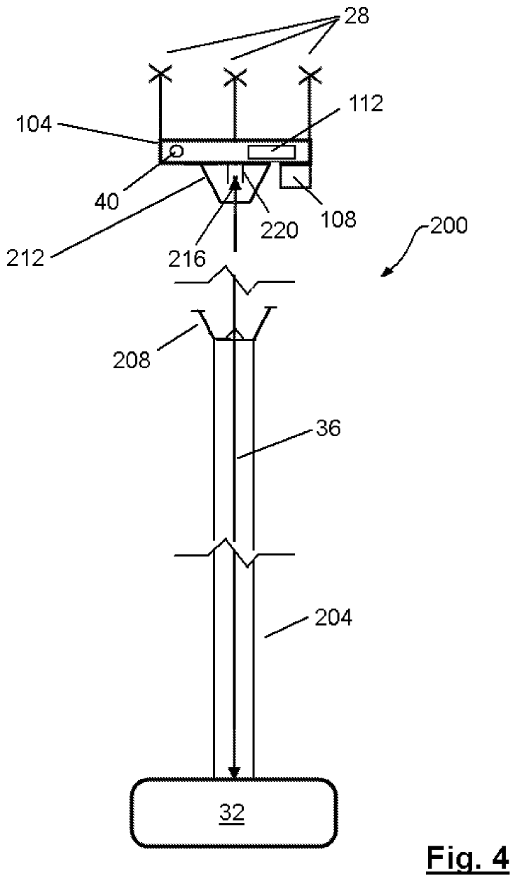

With tether 36 reconnected to UAV 104, via connector 216 and receptacle 220, UAV 104 can then be flown off docking pole 204 and returned to an assigned hover position, above base station 32 with tether 36 extending from the distal end of docking pole 204 to UAV 104 to provide electric power to UAV 104 from base station 32, as shown in FIG. 4. If docking pole 204 is telescopic, it can then be retracted to a storage position, if desired.

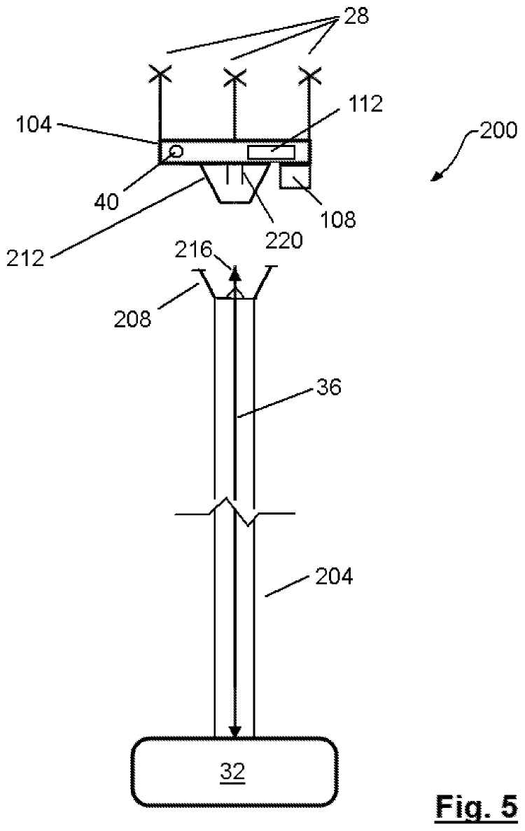

When it is desired to operate UAV 104 in a fully mobile mode again, tether 36 is disconnected from UAV 104, by releasing connector 216 from receptacle 220, and UAV 104 can depart the vicinity of base station 32 using power generated by hybrid drive 108 (if present) or supplied by batteries 40, as shown in FIG. 5. Tether 36 is retracted, by base station 32, until connector 216 is in place, atop docking pole 204, ready for a next docking with, and reattachment to, UAV 104.

System 200 avoids the risk of damage to UAV 104, and/or injury to personnel, which might otherwise occur if UAV 104 was required to land in order to be reattached to tether 36. Further, system 200 eliminates the need for personnel to be present at base station 32 to reattach tether 36.

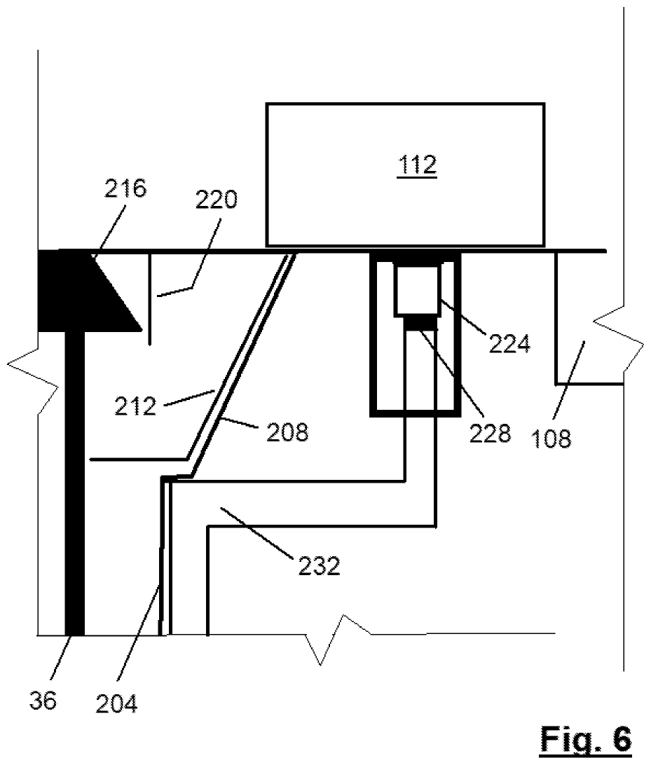

FIG. 6 shows another example of UAV system 200 in accordance with some aspects of the present invention, wherein similar components to those described with respect to FIGS. 1, 2, 3, 4 and 5 are indicated with similar reference numerals. In this embodiment, base station 32 can refuel fuel storage tank 112 when UAV 104 is docked with base station 32.

Specifically, as shown in FIG. 6, when UAV 104 is in a predefined position atop docking pole 204, a self-sealing refueling receptacle 224 on UAV 104 will be aligned with and engage a refueling connector 228 affixed to docking pole 204 and refueling receptacle 224 is connected to fuel storage tank 112. Self-sealing refueling connectors and receptacles are known in within the aerospace arts and the selection and use of suitable such systems are within the knowledge of those of skill in the art and need not be further discussed herein.

Base station 32 is equipped with a fuel source (not shown), such as a fuel storage tank or a hydrogen gas reservoir, and a fuel conduit 232 extends from this fuel source to connector 228. When UAV 104 is appropriately docked in place atop docking pole 204, as shown in FIG. 6, receptacle 224 on UAV 104 connects to refueling connector 228 and is thus connected, via fuel conduit 232, to the fuel source of base station 32. Fuel from the fuel source can be supplied through conduit 232 to fuel storage tank 112, via connector 228 and receptacle 224, to refill fuel storage tank 112. A pump, or other fuel transfer mechanism, is provided in base station 32 to transfer fuel from base station to fuel storage tank 112 and, preferably, the fuel transfer can be controlled programmatically and or via instructions sent to base station 32 from a remote operator, to automatically refuel UAV 104. Thus, in this embodiment, fuel storage tank 112 can be refilled when UAV 104 is docked with base station 32, whether or not an operator is present at base station 32.

It will now be apparent that, after UAV 104 has been untethered and operated in a fully mobile mode of operation, UAV 104 can return to base station 32 to dock and be reattached to tether 36 via connector 216 and receptacle 220 and to the fuel source in base station 32 via connector 228 and receptacle 224 to be electrically powered and refueled, as needed. Once refueled, UAV 104 can be undocked and flown up to a desired hover position over base station 32, with tether 36 attached, without requiring UAV 104 to be landed or UAV 104 can undock, release tether 36, and assume fully mobile flight operations.

It is contemplated that UAV 104 can be manually flown, by an operator, to the location of base station 32 and docking pole 204 to reattach tether 36 and refuel fuel storage tank 112 or that UAV 104 can be flown programmatically, without operator intervention, to base station 32 and docking pole 204 for reattachment to tether 36 and for refueling.

In this latter case, UAV 104 can use a combination of GPS signals, lidar signals, optical reference points, etc. to bring UAV 104 into position to suitably engage docking collar 208 and docking member 212 to reattach tether 36 and to engage connector 224 and receptacle 228 to allow refueling.

Alternatively, docking pole 204 can be equipped with a set of indicator lights, arranged in a known orientation, and those lights can be observed by a camera on UAV 104 and used to align and dock UAV 104, either autonomously, or under operator control, in a desired position. Similarly, microwave-based docking systems can also be employed. As will be apparent to those of skill in the art, such optical and/or microwave based docking systems are well known and need not be further discussed herein.

It is further contemplated that docking pole 204 can be equipped with a landing platform at its upper extremity. In this embodiment (not shown), the landing platform can be equipped with a suitable docking system or other means for positioning UAV 104 at a desired location and orientation to allow for tether reattachment and refueling. If desired, the landing platform can be equipped with a robotic positioning system, such as moveable bumpers (or the like), which can be moved hydraulically, pneumatically, electrically, etc. to position UAV 104 which has landed on the platform into a desired location and/or orientation.

It is further contemplated that in another embodiment, docking pole 204 can be omitted and UAV 104 can land upon a predefined suitable area provided for this purpose, atop, or adjacent, base station 32. In this case, a docking system (such as docking collar 208 and docking member 212 or robotic bumpers, etc.), electrical connector 216 and, if refueling is to be performed, fueling receptacle 228 can be located in the predefined area and function as described above for the previous embodiments.

In any event, as will be apparent, switching between static, hover, and fully mobile operating modes is easily achieved without requiring the presence of ground personnel at base station 32 and extended operations of the UAV system of the present invention can occur without requiring human intervention, beyond directing the flight of the UAV as desired.

The above-described embodiments of the invention are intended to be examples of the present invention and alterations and modifications may be effected thereto, by those of skill in the art, without departing from the scope of the invention which is defined solely by the claims appended hereto.

We claim:

1. An unmanned aerial vehicle system comprising:
an unmanned aerial vehicle equipped with fuel storage and a hybrid drive system operable to produce electrical power to operate the unmanned aerial vehicle using fuel from the fuel storage;
a base station equipped with a tether extending from the base station and having a distal end releasably electrically connected to the unmanned aerial vehicle, the tether operable to provide electrical power from the base station to operate the unmanned aerial vehicle when attached thereto, and wherein the hybrid drive system is operable to provide electrical power to operate the unmanned vehicle aerial vehicle when the tether is released from the unmanned aerial vehicle.

2. The system of claim 1 wherein the base station is equipped with a docking pole supporting the distal end of the tether above the base station and the tether is extendable beyond the end of the docking pole when connected to the unmanned aerial vehicle to permit flight of the unmanned aerial vehicle adjacent the docking pole.

3. The system of claim 2 wherein the unmanned aerial vehicle and the docking pole further include complementary portions of a docking system, the docking system operable to allow the unmanned aerial vehicle to be docked to the docking pole such that the releasable end of the tether is electrically engaged with the unmanned aerial vehicle.

4. The system of claim 3 wherein, once the tether has engaged the unmanned aerial vehicle, the unmanned aerial vehicle can be flown away from the docking pole with the tether attached, power for the unmanned aerial vehicle being supplied through the tether.

5. The system of claim 4 wherein the docking pole can be moved between an extended position wherein the unmanned vehicle can dock and undock from the docking pole and a retracted position.

6. The system of claim 3 wherein the docking pole further includes a fuel supply line and a releasable refueling connector and the unmanned vehicle includes a refueling connector complementary to the releasable refueling connector, the refueling connector on the unmanned aerial vehicle engaging the releasable refueling connector when the unmanned vehicle is docked to allow fuel to be provided to the fuel storage on the unmanned aerial vehicle.

7. The system of claim 1 wherein unmanned aerial vehicle includes a safety interlock operable to ensure that the hybrid drive system produces electricity to power the unmanned aerial vehicle before the tether can be disconnected from the unmanned aerial vehicle.

8. The system of claim 3 wherein the unmanned aerial vehicle includes a flight control system operable to automatically position and dock the unmanned aerial vehicle on the docking pole to engage the tether and reestablish the electrical connection between the unmanned aerial vehicle and the base station.

9. The system of claim 6 wherein the unmanned aerial vehicle includes a flight control system operable to automatically position and dock the unmanned aerial vehicle on the docking pole to re-engage the tether electrically and to engage the refueling connector with the releasable fuel connector to permit fuel to be transferred to the fuel storage on the unmanned aerial vehicle.

10. The system of claim 1 further including a designated landing area associated with the base station, the designated landing area retaining the distal end of the tether and the tether is extendable beyond the designated landing area when connected to the unmanned aerial vehicle to permit flight of the unmanned aerial vehicle adjacent the base station.

11. The system of claim 10 wherein the unmanned aerial vehicle and the designated landing area further include complementary portions of a docking system, the docking system operable to allow the unmanned aerial vehicle to be docked in the designated landing area such that the releasable end of the tether is electrically engaged with the unmanned aerial vehicle.

12. The system of claim 11 wherein, once the tether has engaged the unmanned aerial vehicle, the unmanned aerial vehicle can be flown away from the designated landing area with the tether attached, power for the unmanned aerial vehicle being supplied through the tether.

13. The system of claim 11 wherein the designated landing area further includes a fuel supply line and a releasable refueling connector and the unmanned vehicle includes a refueling connector complementary to the releasable refueling connector, the refueling connector on the unmanned aerial vehicle engaging the releasable refueling connector when the unmanned vehicle is docked to allow fuel to be provided to the fuel storage on the unmanned aerial vehicle.

14. An unmanned aerial vehicle system comprising:
an unmanned aerial vehicle equipped with at least one battery to provide electrical power to operate the vehicle;
a base station equipped with a docking pole and a tether having a first end at the base station and a second end extendable from the distal end of the docking pole, the second end having a releasable electrical connection to connect to the unmanned aerial vehicle, the tether operable to provide electrical power from the base station to operate the unmanned vehicle aerial vehicle and to charge the at least one battery when the electrical connection is connected to the unmanned aerial vehicle and
a docking system, comprising a first member located on the docking pole and a second member located on the unmanned aerial vehicle, the docking system cooperating to receive the unmanned aerial vehicle at the end of the docking pole distal the base station and to reconnect the releasable electrical connection at the second end of the tether to the unmanned aerial vehicle.

15. The unmanned aerial vehicle system of claim 14 wherein, when the releasable electrical connection is connected to and is powering the unmanned aerial vehicle, the unmanned aerial vehicle can be flown off of the docking pole and the tether will extend from the docking pole to maintain an electrical connection between the unmanned aerial vehicle and the base station.

16. An unmanned aerial vehicle comprising:
fuel storage;
a hybrid drive system operable to produce electrical power to operate the unmanned aerial vehicle using fuel from the fuel storage;
an electrical receptacle operable to releasably engage an electrical connector on a tether, which can provide electrical power to operate the unmanned aerial vehicle when attached thereto and wherein the hybrid drive system produces electricity to power the unmanned aerial vehicle when the tether is released from the electrical receptacle.

17. An unmanned aerial vehicle according to claim 16 wherein the unmanned vehicle can be positioned at a predefined position to re-engage the electrical connector of the tether with the electrical receptacle to again supply electrical power to the unmanned aerial vehicle.

18. An unmanned aerial vehicle according to claim 17 wherein the unmanned aerial vehicle is put into the predefined position by the interaction of a docking element on the unmanned aerial vehicle and a docking element located at the predefined position.

19. An unmanned aerial vehicle according to claim 18 further comprising a refueling receptacle in fluid communication with the fuel storage wherein, when the unmanned aerial vehicle is in the predefined position, the refueling receptacle engages a refueling connector connected to a fuel source to enable the transfer of fuel from the fuel source to the fuel storage to allow the fuel storage to be refilled.

20. A method of operating an unmanned aerial vehicle system, comprising the steps of:
releasably connecting a tether to an unmanned aerial vehicle, the tether providing electrical power to operate the unmanned aerial vehicle wile attached to the tether;
starting a hybrid drive system on the unmanned aerial vehicle, the hybrid drive system generating electrical power from fuel stored in fuel storage on the unmanned aerial vehicle, the generated electrical power operating the unmanned aerial vehicle; and
releasing the tether from the unmanned aerial vehicle when the unmanned aerial vehicle is powered by the hybrid drive system to allow the unmanned aerial vehicle to operate in a fully mobile manner.

21. A method of operating an unmanned aerial vehicle according to claim 20 further comprising the steps of: positioning the unmanned aerial vehicle at a predefined position wherein the tether is reconnected to the unmanned aerial vehicle, the tether again providing electrical power to the unmanned aerial vehicle and stopping the hybrid drive system.

22. A method of operating an unmanned vehicle according to claim 21 wherein in the predefined position the unmanned aerial vehicle is releasably connected to a refueling connector allowing fuel to be resupplied to the fuel storage on the unmanned aerial vehicle.
